(19) United States
(12) Patent Application Publication
(10) Pub. No.: US 2024/0303480 A1
(43) Pub. Date: Sep. 12, 2024

(54) SYSTEMS AND METHODS FOR TRAINING NEURAL NETWORKS USING OPTICAL HARDWARE

(71) Applicant: SATHVIK REDROUTHU, Ashburn, VA (US)

(72) Inventors: SATHVIK REDROUTHU, Ashburn, VA (US); PRANAV VADDE, Ashburn, VA (US); JAGADEEPRAM MADDIPATLA, Ashburn, VA (US)

(21) Appl. No.: 18/119,437

(22) Filed: Mar. 9, 2023

(51) Int. Cl. G06N 3/08

(52) U.S. Cl. CPC G06N 3/08

(57) ABSTRACT

A Vector Processing Unit (VPU) comprises a plurality of core clusters comprising multiple Single Instruction Multiple DataStream (SIMD) cores, wherein each SIMD core comprises at least one Optical Arithmetic Unit (OAU). The VPU may be configured to receive instructions as digital input vectors, determine information related to light intensities and arithmetic operations, and transmit the digital input vectors and the determined information to at least one of the plurality of core clusters. The plurality of core clusters is configured to receive the digital input vectors and related information. The data is then converted to analog form which is again converted to light beams. The light beams are multiplexed to generate an operand that is processed by the OAU to generate a result. The result is again converted to digital signal and sent to the VPU.

### FIELD OF THE INVENTION

The present invention relates to the field of computer architecture and more specifically to a Vector Processing Unit (VPU) using Optical Arithmetic Unit (OAU) for data processing.

### BACKGROUND OF THE INVENTION

Artificial intelligence (AI) applications have become increasingly data-intensive, with neural networks (NNs) growing in size exponentially. Some noteworthy mentions include GPT's 117 million to 175 billion parameters, DeepMind's Gato's 79 million to 1.2 billion, and WuDao's recent breakthrough of 1.75 trillion parameters. This increase in NN feature size has resulted in a surge in demand for high-performance per watt chips, with companies developing powerful support hardware to meet the requirements of even future model iterations.

Traditionally, GPUs have been extensively used for NNs because of their ability to massively parallelize computing. However, we are approaching the end of Dennard Scaling, which implies that meeting demands for performance gains solely through engineering smaller transistors will no longer be feasible. As a result, microprocessor companies are compelled to reimagine the fabrication and design process with every new chip design, leading to an era of hardware accelerators. As data usage is predicted to continue growing at an exponential rate, power-efficient data processing hardware is in high demand. The use of digital accelerators preferred by some companies is merely a temporary fix for hardware limitations due to their dependence on transistors.

Therefore, alternatives such as analog computing and silicon photonics are being dependent upon in recent times. Silicon photonic hardware has the advantage of avoiding problems associated with electromagnetic crosstalk and Joule heating, leading to a reduction in real-time data center expenses.

It is therefore imperative that the benefits of silicon photonics be brought into the NN training space, and that R&D be carried out to ensure sustainability throughout the future as NN parameters scale. The end of Moore's Law and Dennard Scaling for digital electronic computer architectures necessitates significant time and monetary investment in high-risk R&D, which is likely unsustainable for future models if it remains transistor-based. Hence, exploring alternatives such as analog computing and silicon photonics is essential. Bringing the benefits of silicon photonics into the NN training space will be a significant step forward in addressing the challenges associated with NN feature size growth and ensuring the development of sustainable and efficient hardware for AI applications in the future.

US20200379504A1 discloses an optical neural network that is constructed based on photonic integrated circuits to perform neuromorphic computing. In the optical neural network, matrix multiplication is implemented using one or more optical interference units, which can apply an arbitrary weighting matrix multiplication to an array of input optical signals. Nonlinear activation is realized by an optical nonlinearity unit, which can be based on nonlinear optical effects, such as saturable absorption. These calculations are implemented optically, thereby resulting in high calculation speeds and low power consumption in the optical neural network.

US20210287078A1 advantageously provides an Optical Hardware Accelerator (OHA) for an Artificial Neural Network (ANN) that includes a communication bus interface, a memory, a controller, and an optical computing engine (OCE). The OCE is configured to execute an ANN model with ANN weights. Each ANN weight includes a quantized phase shift value θi and a phase shift value ϕi. The OCE includes a digital-to-optical (D/O) converter configured to generate input optical signals based on the input data, an optical neural network (ONN) configured to generate output optical signals based on the input optical signals, and an optical-to-digital (O/D) converter configured to generate the output data based on the output optical signals. The ONN includes a plurality of optical units (OUs), and each OU includes an optical multiply and accumulate (OMAC) module.

US20200372344A1 discloses a concept for training a neural network model. The concept comprises receiving training data and test data, each comprising a set of annotated images. A neural network model is trained using the training data with an initial regularization parameter. Loss functions of the neural network for both the training data and the test data are used to modify the regularization parameter, and the neural network model is retrained using the modified regularization parameter. This process is iteratively repeated until the loss functions both converge. A system, method and a computer program product embodying this concept are disclosed.

US20210056358A1 discloses an optical processing system that comprises at least one spatial light modulator, SLM, configured to simultaneously display a first input data pattern (a) and at least one data focusing pattern which is a Fourier domain representation (B) of a second input data pattern (b), the optical processing system further comprising a detector for detecting light that has been successively optically processed by said input data patterns and focusing data patterns, thereby producing an optical convolution of the first and second input data patterns, the optical convolution for use in a neural network.

Vector processing is a type of processing that allows multiple data elements to be processed in parallel. It is used in many areas such as scientific computing, image processing, and machine learning. Optical AU (Arithmetic Unit) is a type of hardware that uses light-based circuits to perform arithmetic. It has the potential to offer faster processing speeds and lower power consumption compared to traditional electronic-based ALUs. The present disclosure uses Optical AU in a Vector Processing Unit (VPU) to achieve substantial improvement in performance over conventional systems. The VPU is an optical architecture meant to train Neural Networks (NNs). The VPU provides a solution for efficient NN training able to be applied at scale.

### SUMMARY OF THE INVENTION

In light of the disadvantages mentioned in the previous section, the following summary is provided to facilitate an understanding of some of the innovative features unique to the present invention and is not intended to be a full description. A full appreciation of the various aspects of the invention can be gained by taking the entire specification and drawings as a whole.

Embodiments of the present disclosure propose a Vector Processing Unit (VPU) capable of training Neural Networks efficiently. The VPU may comprise a plurality of core clusters, wherein each of the plurality of core clusters comprises multiple Single Instruction Multiple DataStream (SIMD) cores. Herein, Each SIMD core may comprise at least one Optical Arithmetic Unit (OAU).

The VPU may be configured to receive instructions as digital input vectors and determine information related to light intensities and arithmetic operations corresponding to the received digital input vectors. Further, the VPU may be configured to transmit the digital input vectors and the determined information to at least one of the plurality of core clusters. At least one of the plurality of core clusters may be configured to receive the digital input vectors and determine information related to the light intensities and arithmetic operations corresponding to the digital input vectors. Further, at least one of the plurality of core clusters may be configured to convert the digital input vectors to analog form and transmit the input in analog form to a laser array for generating corresponding light beams. Further, the light beams may be multiplexed to generate an operand which may be processed using at least one OAU to generate a result. The result may be demultiplexed and transmitted to photodetectors which convert the result to an analog form. The result which is in analog form may further be converted to digital form and may be transmitted to the VPU.

This summary is provided merely for the purpose of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures.

The abovementioned embodiments and further variations of the proposed invention are discussed further in the detailed description.

### BRIEF DESCRIPTION OF THE DRAWINGS

FIG. 1 is an exemplary block diagram of the architecture of an optical hardware accelerator for DNN (Deep Neural Network) training and inference according to the embodiments of the present disclosure;

FIG. 2 is an exemplary block diagram of a multicore MIMD (Multiple Instruction and Multiple Data Stream) architecture to execute kernel grids according to the embodiments of the present disclosure;

FIG. 3 is an exemplary block diagram of a multicore MIMD architecture to execute thread blocks according to the embodiments of the present disclosure;

FIG. 4 is a block diagram of an exemplary SIMD (Single instruction multiple data) architecture to execute z-thread warps according to the embodiments of the present disclosure;

FIG. 5 is an exemplary block diagram of the silicon photonic architecture to perform basic arithmetic within the analog domain according to the embodiments of the present disclosure;

FIG. 6 is an exemplary block diagram of an optical switch network according to the embodiments of the present disclosure.

### DETAILED DESCRIPTION

In the following description of the embodiments of the invention, reference is made to the accompanying drawings that form a part hereof, and in which are shown by way of illustration-specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limited sense, and the scope of the present invention is defined only by the appended claims.

The specification may refer to “an”, “one” or “some” embodiment(s) in several locations. This does not necessarily imply that each such reference is to the same embodiment(s), or that the feature only applies to a single embodiment. A single feature of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the foregoing sections, some features are grouped together in a single embodiment for streamlining the disclosure. This method of disclosure is not to be interpreted as reflecting an intention that the disclosed embodiments of the present disclosure must use more features than are expressly recited in each claim. Rather, as the following claims reflect, the inventive subject matter lies in less than all features of a single disclosed embodiment. Thus, the following claims are hereby incorporated into the detailed description, with each claim standing on its own as a separate embodiment.

As used herein, the symbol “n” denotes max supported input vector size (vectors with dim<n padded with 0s); “x” denotes grid size (number of thread blocks supported in kernel grid, denotes VPU “size”); “y” denotes block size (number of warps supported in thread block); “z” denotes warp size (number of threads supported in warp). Terminology is consistent with Nvidia's Complete Unified Device Architecture (CUDA) system for ease of use to those familiar.

According to the embodiments of the present disclosure, systems, and methods capable of training Neural Networks (NNs) using optical hardware accelerators are proposed. Herein, a Vector Processing Unit (VPU) 102 may handle the process of data processing for the purpose of NN training. The VPU 102 may comprise a plurality of core clusters. Each core cluster further comprises multiple Single Instruction Multiple DataStream (SIMD) cores. Furthermore, each SIMD core may comprise at least one Optical Arithmetic Unit (OAU).

SIMD cores are a type of processor architecture that is designed to perform the same operation on multiple pieces of data simultaneously. In other words, SIMD processors may execute a single instruction on multiple data items in parallel, which may provide a significant performance improvement for certain types of computations.

The idea behind SIMD is to use a single instruction to perform the same operation on multiple data items at once. For example, if two vectors are to be added, a single instruction to add the corresponding elements of each vector together may be used. This can be much faster than using a sequence of instructions to perform the same operation on each element of the vector individually.

SIMD architectures are commonly used in applications like image and video processing, scientific computing and data analysis, neural network training, and the like, where large arrays of data need to be processed quickly.

An Optical AU, or Optical Arithmetic Unit, is a type of integrated circuit that performs arithmetic operations on optical signals. In other words, it is a photonic device that uses light instead of electricity to process information. Optical AUs may perform mathematical operations such as addition, subtraction, and multiplication on optical signals. These operations may be performed by manipulating the intensity, phase, polarization, or wavelength of the optical signals. Optical AUs have applications in areas such as optical computing, optical communication, and high-speed data processing.

The VPU 102 may be configured to receive instructions as digital input vectors and determine information related to light intensities and arithmetic operations corresponding to the received digital input vectors. Further, the VPU 102 may be configured to transmit the digital input vectors and the determined information to at least one of the plurality of core clusters.

The VPU 102 may be configured to distribute the digital input vectors and the determined information to at least one of the plurality of cores over a serial communications protocol. The protocol consists of a master-slave architecture, where one device acts as the master and controls the communication, while one or more devices act as slaves and respond to the master's commands. Communication between the master and slave devices is accomplished through a series of data and clock signals. The master initiates communication by selecting the slave device using the SS (Slave Select: A signal line that allows the master to select which slave device it wants to communicate with) line, and then sends data through the MOSI line (Master Output, Slave Input: The master sends data to the slave device through this line) and receives data from the MISO line (Master Input, Slave Output: The slave sends data back to the master through this line).

The VPU 102 herein is a specialized processor that is designed to perform mathematical operations on vectors or arrays of data. VPU 102 is commonly used in high-performance computing systems such as scientific simulations, computer graphics, and image and signal processing. VPUs are optimized to handle data in parallel, which allows them to perform multiple operations on large datasets simultaneously. This is achieved through the use of vector instructions, which are designed to operate on multiple data elements at once. In contrast to traditional scalar processors, which perform operations on individual data elements, VPUs can process large volumes of data with a single instruction. This makes them well-suited for tasks that require intensive computations on large datasets, such as video encoding and decoding, 3D graphics rendering, machine learning, neural network training, and the like. VPUs may be integrated into a larger system, such as a CPU, or they can be used as standalone processors.

The plurality of core clusters herein may be configured to receive the digital input vectors and determine information related to the light intensities and arithmetic operations corresponding to the digital input vectors. Further, at least one of the plurality of core clusters may be configured to convert the digital input vectors to analog form and transmit the input in analog form to a laser array for generating corresponding light beams. Herein, the plurality of core clusters converts the digital input vectors to analog form using an array of Digital to Analog Converters (DACs).

Further, the light beams may be multiplexed to generate an operand. Herein, the plurality of core clusters multiplexes the light beams using silicon photonic mode division (MD) multiplexers. Silicon photonic MD multiplexers are a type of optical multiplexer that use the properties of light to enable high-speed data transmission in optical communication systems. MD multiplexers operate by dividing and transmitting multiple data channels using different modes of light through a waveguide. Silicon photonic MD multiplexers are based on the principles of mode-division multiplexing (MDM), which is a technique that allows multiple optical signals to be transmitted simultaneously through different optical modes. Silicon photonics is a technology that uses silicon-based integrated circuits to control and manipulate light signals. In an MD multiplexer, light is injected into a waveguide that splits into multiple branches. Each branch guides light into a different mode, which is a unique way that light can propagate through the waveguide. The different modes carry different data channels, allowing multiple channels to be transmitted simultaneously through the same waveguide. The advantages of silicon photonic MD multiplexers include high data rates, low power consumption, and compatibility with existing optical communication systems. They are also relatively easy to fabricate using standard semiconductor processing techniques.

Further, the generated operand may be processed using at least one OAU to generate a result. The generated result may be demultiplexed and transmitted to photodetectors which convert the result to an analog form. The result which is in analog form may further be converted to digital form and may be transmitted to the VPU 102. Herein, the plurality of core clusters converts the result from analog form to digital form using an array of Analog to Digital Converters (ADCs). The core clusters demultiplexes the result using mode division (MD) demultiplexers. Further, the plurality of core clusters transmits the result in digital form to the VPU 102 over a serial communications protocol.

In one example, the VPU 102 may be configured to determine information related to light intensities and arithmetic operations corresponding to the received digital input vectors by toggling an array of laser light with an amplitude of each beam corresponding to an element in the received digital input vectors. Herein, the VPU 102 may be configured to receive digital input vectors as its input. The VPU 102 may be connected to an array of laser lights, where each laser beam corresponds to an element in the input vector. When the digital input vectors are received by the VPU 102, the VPU 102 may use the input vectors to control the amplitude of each laser beam in the array. The laser beams may be toggled on and off, with the amplitude of each beam corresponding to an element in the input vector. This may create a pattern of light intensities that corresponds to the input vector. This information is passed on to the core clusters for processing.

Herein, the VPU 102 acts as the master while the core clusters comprises slave microcontrollers wherein the communication is performed over a serial communications protocol.

The systems and methods disclosed do not rely much on transistors and therefore do not depend heavily on Moore's Law and Dennard Scaling trends. It may also reduce problems related to overheating and interference that are common in electronic designs. Unlike digital electronic systems, the proposed system may not require more computing power to run inference with increasing NN feature size in silicon photonics. The proposed system and method may also train NNs optically. Moreover, the proposed solution may be an alternative to the GPU with the arithmetic-logic unit (ALU) count per Streaming Multiprocessor decreased by a factor of z, leaving more space for additional processing hardware.

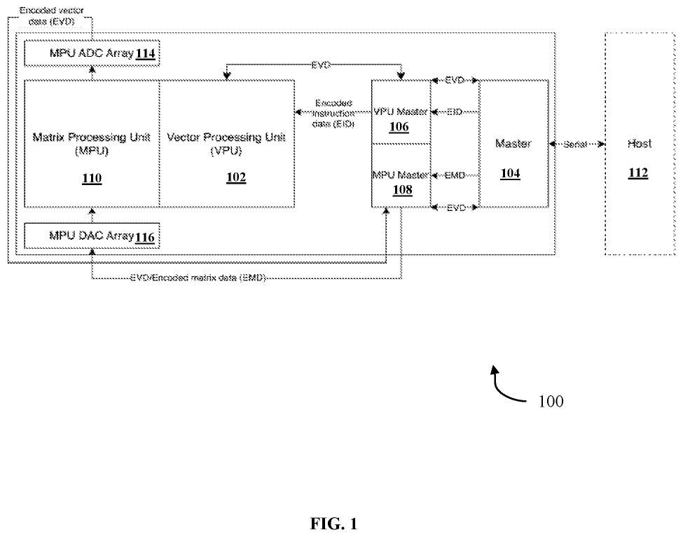

FIG. 1 is an exemplary block diagram 100 of the architecture of an optical hardware accelerator for DNN (Deep Neural Network) training and inference according to the embodiments of the present disclosure. According to an embodiment of the present disclosure, the optical hardware architecture comprises of the VPU (102), Master 104, VPU Master 106, MPU Master 108, MPU (Matrix Processing Unit) 110, Host 112, MPU ADC Array 114, and MPU DAC Array 116.

According to an embodiment of the present disclosure, one of the objectives of the optical hardware accelerator comprises computing matrix-vector multiplication, element-wise vector addition, subtraction, and multiplication optically, wherein all the operations are carried out in constant time.

According to an embodiment of the present disclosure, the architecture comprises two subunits MPU 110 for NN inference and VPU 102 for NN training, wherein the MPU performs matrix-vector multiplication whereas the VPU 102 performs element-wise vector operations in parallel.

According to an embodiment of the present disclosure, the VPU master receives instructions from the host, a pair of vectors and an instruction and/or a vector and matrix multiple.

According to an embodiment of the present disclosure, the Master 104 sends digitally encoded vector and matrix data to the MPU master 108, which routes each element to the MPU DAC array 116. According to an embodiment of the present disclosure, each analog signal vector element is sent to a corresponding laser, tuning corresponding light beams to a specific intensity, while the analog matrix data is sent to a series of modulators in the MPU 110. These perform phase shifts to carry out matrix-vector multiplication. The optical signals representing the resultant vector elements are sent to photodetectors and converted into electronic analog signals, which are sent to the MPU ADC Array 114 to be converted to digital signals. The elements in digital representation are then sent back to the MPU Master 108 which communicates the result with the Master 104 and the Host 112.

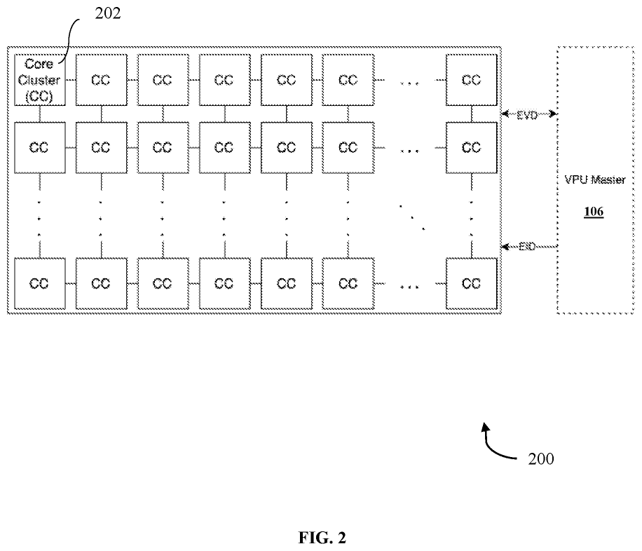

FIG. 2 is an exemplary block diagram 200 of a multicore MIMD (Multiple Instruction and Multiple Data Stream) architecture to execute kernel grids according to the embodiments of the present disclosure. According to an embodiment of the present disclosure, the multicore MIMD (Multiple Instruction and Multiple Data Stream) architecture consists of the VPU master 106 and the core cluster (CC) 202.

According to an embodiment of the present disclosure, the VPU architecture performs element-wise addition, subtraction and multiplication in a MIMD fashion on large vectors. A digitally encoded n-dimensional vector sent to the VPU from a master controller is partitioned into (n/x)-dim subvectors and routed to the various core clusters (CCs) 202. Each core cluster accepts 2 subvectors partitioned from the 2 initial vectors. Each core cluster performs the requested operation independently, wherein the resultant subvectors are then sent back to the master and recombined into the final resultant vector.

According to an embodiment of the present disclosure, different operations can be performed on the partitioned subvectors by each core within a CC simultaneously. The VPU master 106 receives encoded instruction data (EID) through a bit string, which is decomposed into a series of 2-bit instruction signals (encapsulating 3 possible operations) and routed to cores within each CC. Further VPU master 106 can execute x-block kernel grids.

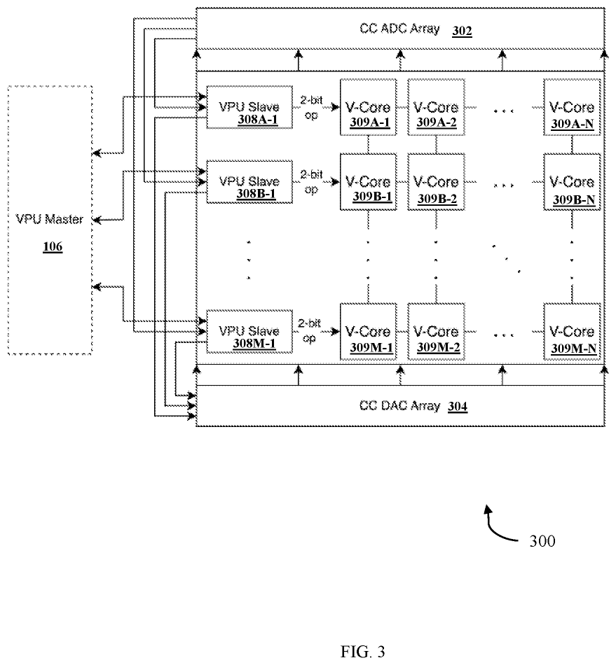

FIG. 3 is an exemplary block diagram 300 of a multicore MIMD architecture to execute thread blocks according to the embodiments of the present disclosure. According to an embodiment of the present disclosure, the multicore MIMD architecture comprises of VPU master 106, CC ADC array 302, CC DAC array 304, VPU slave 308A-1, 308B-1, 308M-N, V-Core 309A-1, 309A-2, 309A-N, V-Core 309B-1, 309B-2, 309B-N, V-Core 309M-1, 309M-2 and 309M-N. According to an embodiment of the present disclosure, the multicore MIMD architecture performs element-wise addition, subtraction, and multiplication in a MIMD fashion on digitally encoded subvectors sent by the VPU master 106.

According to an embodiment of the present disclosure, the subvector elements are sent to VPU slaves 308A-1, 308B-1, 308M-N which send elements to a DAC array 304. The resulting analog signals are sent to a group of V-Cores 309A-1, 309A-2, 309A-N, 309B-1, 309B-2, 309B-N, 309M-1, 309M-2 and 309M-N which each perform element-wise operations on further partitioned sub-vectors in a SIMD fashion. The V-Core output (analog signal) is sent to the ADC array 302 and routed back to each corresponding VPU slave 308A-1, 308B-1, 308M-N, wherein the results are communicated to the VPU master 106 for usage and wherein each CC 202 can execute a y-warp thread block.

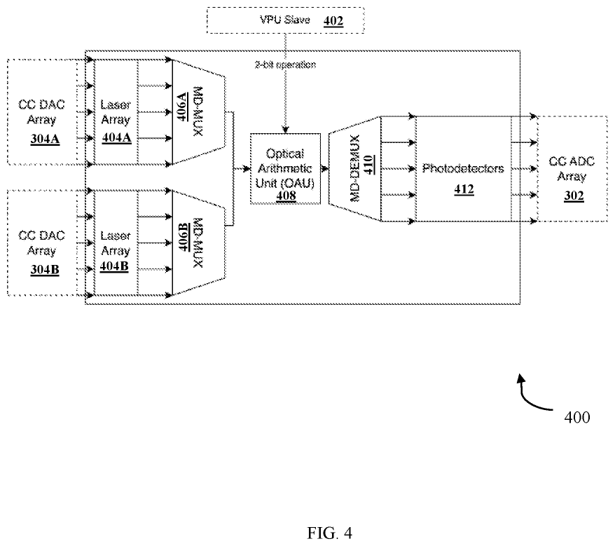

FIG. 4 is a block diagram 400 of an exemplary SIMD (Single instruction multiple data) architecture to execute z-thread warps according to the embodiments of the present disclosure. According to an embodiment of the present disclosure, the SIMD comprises of VPU Slave 402, CC ADC Array 302, CC DAC Array 304A, 304B, VPU slave 402, Laser array 404A, 404B, MD-MUX 406A, 406B, optical arithmetic unit (OAU) 408, MD-DEMUX 410 and photodetectors 412. According to an embodiment of the present disclosure, SIMD architecture performs element-wise operations on further partitioned sub-vectors in a SIMD fashion on z elements at a time.

According to an embodiment of the present disclosure, each of the z-channel current streams drives z lasers, implicitly representing 2 vectors each containing z floating-point values, wherein the 2 sets of light waves are mode-multiplexed into 2 beams representing each vector. Further, the beams are sent to the OAU 408, which returns a single output beam after executing the supplied instruction. The output beam is demultiplexed into z light waves, each of which is sent to a photodetector to be covered into z analog signals and sent to the ADC array 302, wherein each V-core can execute a z-thread warp. Further, the VPU slave 402 does not trigger the lasers to activate until both vectors are initialized.

According to an embodiment of the present invention, the VPU master 106 receives multiple sets of 2 z-dimensional vectors and an operation to carry out on each pair of vectors from the host computer via the master. The VPU master 106 then distributes the input vectors and the appropriate operation to each V-Core (2 subvectors and 1 operation per V-Core), which are controlled by the VPU Slaves. The VPU Slaves send the vector pair assigned to it to the Core Cluster's DAC Array, which converts each element in each vector from a floating point (FP) number in binary to an analog signal. The analog signals for each vector get sent to a Laser Array, which creates a series of z light beams. The light beams representing each element in a vector then get multiplexed into a common signal, creating 2 multiplexed optical signals representing the 2 vectors to perform operations on. These multiplexed signals are sent to the OAU, where the requested operation is carried out. The OAU outputs a single multiplexed signal encoding the resultant subvector. This is demultiplexed into z individual light beams representing the elements. These light signals are then sent to the core's photodetector array, which outputs an analog signal for each optical signal. These analog signals are sent to the CC's ADC Array, which converts them to FP numbers represented in binary signals. These then get sent back to the VPU Slave which communicates the result to the VPU Master 106 and the host computer.

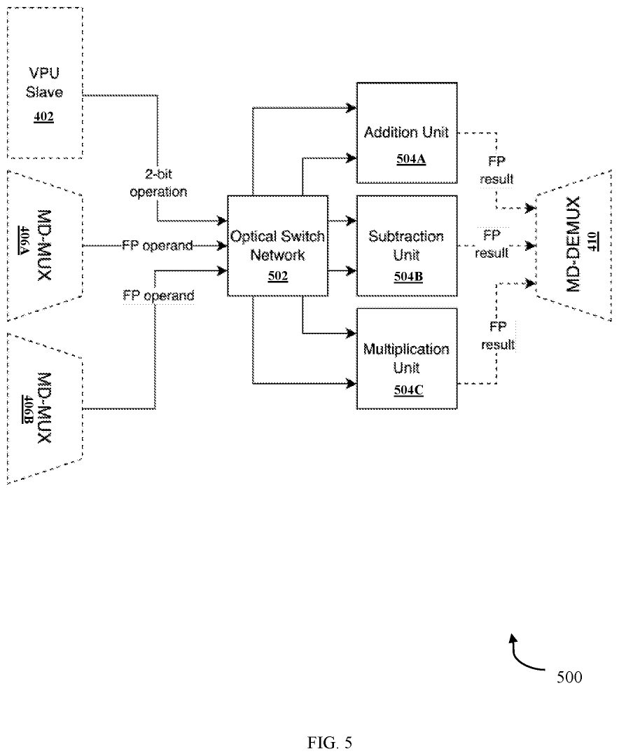

FIG. 5 is an exemplary block diagram 500 of the silicon photonic architecture to perform basic arithmetic within the analog domain according to the embodiments of the present disclosure. According to an embodiment of the present disclosure, the silicon photonic architecture comprises of VPU slave 402, MD-MUX 406A, MD-MUX 406B, MD-DEMUX 410, optical switch network 502, addition unit 504A, subtraction unit 504B and multiplication unit 504C. According to an embodiment of the present disclosure, the silicon photonic architecture performs an element-wise vector addition, subtraction and multiplication in a SMID fashion on z elements at a time.

According to an embodiment of the present disclosure, the OAU takes two floating point operands (encoded within light waves) and performs the 2-bit encoded operation sent by the VPU slave 402. The 2-bit operation toggles a pathway in the Optical Switch Network that guides the light waves to the correct compute unit. The FP operands enter the corresponding compute unit; the output is a single FP result. This gets sent out of the OAU and into the mode-division demultiplexer in the V-Core.

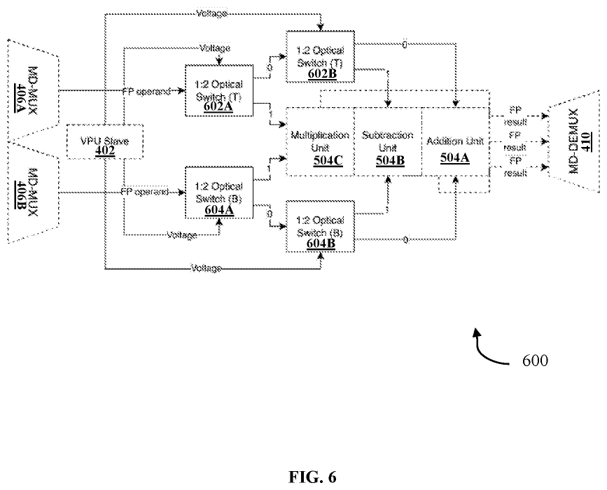

FIG. 6 is an exemplary block diagram 600 of an optical switch network according to the embodiments of the present disclosure. According to an embodiment of the present disclosure, the optical switch network comprises of VPU slave 402, MD-MUX 406A, MD-MUX 406B, MD-DEMUX 410, addition unit 504A, subtraction unit 504B and multiplication unit 504C, 1:2 optical switch (T) 602A, 1:2 optical switch (T) 602B, 1:2 optical switch (B) 604A and 1:2 optical switch (B) 604B. According to an embodiment of the present disclosure, the optical switch network routes inputs to the correct compute unit.

According to an embodiment of the present disclosure, the optical switch network to guide FP operands to the correct compute units based on digitally encoded operation from VPU slave 402. Each 1:2 optical switch is a Mach-Zehnder Interferometer (MZI) with 1 input port and 2 output ports (from an integrated directional coupler). T indicates a modulator on the top interferometer arm while B indicates one on the bottom interferometer arm. When a digital 1 is specified, a corresponding voltage is sent to the switch modulator from the VPU slave 402 to change the light beam's path.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications, and changes may be made without departing from the spirit of the present solution. All the features disclosed in this specification (including any accompanying claims, abstract, and drawings), and all of the steps of any method or process so disclosed, may be combined in any combination, except combinations where at least some of such features or steps are mutually exclusive.

The terms “include,” “have,” and variations thereof, as used herein, have the same meaning as the term “comprise” or an appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A Vector Processing Unit (VPU) comprising:
a plurality of core clusters, wherein each of the plurality of core clusters comprises multiple Single Instruction Multiple DataStream (SIMD) cores, wherein each SIMD core comprises at least one Optical Arithmetic Unit (OAU), the VPU is configured to:
receive instructions as digital input vectors;
determine information related to light intensities and arithmetic operations corresponding to the received digital input vectors;
transmit the digital input vectors and the determined information to the at least one of the plurality of core clusters configured to:
receive the digital input vectors and determined information related to the light intensities and arithmetic operations corresponding to the digital input vectors;
convert the digital input vectors to analog form and transmit the input in analog form to a laser array for generating corresponding light beams;
multiplex the light beams to generate an operand;
process the operand using the at least one OAU to generate a result;
demultiplex the result and transmit the demultiplexed result to photodetectors which converts the result to an analog form;
convert the result in the analog form to a digital form and transmit the result in the digital form to the VPU slave, then back to the VPU master.

2. The VPU of claim 1, wherein the VPU is configured to transmit the digital input vectors and the determined information to at least one of the plurality of cores.

3. The VPU of claim 1, wherein at least one of the plurality of core clusters converts the digital input vectors to analog form using an array of Digital to Analog Converters (DACs).

4. The VPU of claim 1, wherein at least one of the plurality of core clusters converts the result in analog form to digital form using an array of Analog to Digital Converters (ADCs).

5. The VPU of claim 1, wherein at least one of the plurality of core clusters multiplexes the light beams using silicon photonic mode division (MD) multiplexers.

6. The VPU of claim 1, wherein at least one of the plurality of core clusters demultiplexes the result using mode division (MD) demultiplexers.

7. The VPU of claim 1, wherein at least one of the plurality of core clusters transmits the result in digital form to the VPU slave.

8. The VPU of claim 1, wherein the VPU is configured to determine information related to light intensities and arithmetic operations corresponding the received digital input vectors by toggling an array of laser light with an amplitude of each beam corresponding to an element in the received digital input vectors.

9. A VPU implemented method comprising:
receiving instructions as digital input vectors;
determining information related to light intensities and arithmetic operations corresponding the received digital input vectors;
transmitting the digital input vectors and the determined information to the at least one of the plurality of core clusters for:
receiving the digital input vectors and determined information related to the light intensities and arithmetic operations corresponding to the digital input vectors;
converting the digital input vectors to analog form and transmit the input in analog form to a laser array for generating corresponding light beams;
multiplexing the light beams to generate an operand;
processing the operand using the at least one Optical AU to generate a result;
demultiplexing the result and transmit the demultiplexed result to photodetectors which converts the result to an analog form;
converting the result in the analog form to a digital form and transmitting the result in the digital form to the VPU.

10. The VPU implemented method of claim 9, wherein the VPU transmits the digital input vectors and the determined information to at least one of the plurality of cores over a serial communications protocol.

11. The VPU implemented method of claim 9, wherein at least one of the plurality of core clusters converts the digital input vectors to analog form using an array of Digital to Analog Converters (DACs).

12. The VPU implemented method of claim 9, wherein at least one of the plurality of core clusters converts the result in analog form to digital form using an array of Analog to Digital Converters (ADCs).

13. The VPU implemented method of claim 9, wherein at least one of the plurality of core clusters multiplexes the light beams using silicon photonic mode division (MD) multiplexers.

14. The VPU implemented method of claim 9, wherein at least one of the plurality of core clusters demultiplexes the result using mode division (MD) demultiplexers.

15. The VPU implemented method of claim 9, wherein at least one of the plurality of core clusters transmits the result in digital form to the VPU over a serial communications protocol.

16. The VPU implemented method of claim 9, wherein the VPU determines information related to light intensities and arithmetic operations corresponding to the received digital input vectors by toggling an array of laser light with an amplitude of each beam corresponding to an element in the received digital input vectors.
